(19) United States
(12) Patent Application Publication
(10) Pub. No.: US 2017/0242668 A1
(43) Pub. Date: Aug. 24, 2017

(54) CONTENT PUBLISHING

(71) Applicant: Microsoft Technology Licensing, LLC, Redmond, WA (US)

(72) Inventor: Ricardo Loo Foronda, Seattle, WA (US)

(73) Assignee: Microsoft Technology Licensing, LLC, Redmond, WA (US)

(21) Appl. No.: 15/052,480

(22) Filed: Feb. 24, 2016

(51) Int. Cl. G06F 9/44; G06F 11/36

(52) U.S. Cl. CPC G06F 8/36; G06F 11/3668

(57) ABSTRACT

An example system for content publishing includes a computer processor and computer memory including instructions that cause the computer processor to present a first code sample having a first functionality in response to a request for the first functionality. The instructions also cause the processor to detect an association between the first code sample and a second code sample having a second functionality, wherein the association indicates the first code sample is dependent on the second code sample. The instructions further cause the processor to generate, in response to a selection of the first code sample, a build file based on the first code sample and the second code sample. The instructions also further cause the processor to generate a package including the first functionality and the second functionality based on the build file.

### BACKGROUND

A content publisher is a software company that provides operating systems, applications, and networked architectures for various computing devices, from wearable devices and smartphones to laptop and desktop computers. For example, Microsoft®, Google®, and Apple® are some popular content publishers. Applications that are executed on these devices may include communication and organizational tools, educational and entertainment technologies, and so on. These applications are written by developers, who rely on content publishers to provide code samples that developers use to write their various applications. The code samples are source code files that, when compiled or interpreted into an executable form, perform a service on the content publisher's platform. A service is a computer operation that provides some functionality to a customer, such as sending an email or transmitting data corresponding to an online chat. To encourage potential customers to send email and perform other services on platforms, content providers can provide source code samples that developers can integrate into their applications. Content publishers make these source code samples available to developers to encourage developers to write applications that use the content publishers' technologies and services.

### SUMMARY

The following presents a simplified summary of the innovation in order to provide a basic understanding of some aspects described herein. This summary is not an extensive overview of the disclosed subject matter. It is intended to neither identify key elements of the disclosed subject matter nor delineate the scope of the disclosed subject matter. Its sole purpose is to present some concepts of the disclosed subject matter in a simplified form as a prelude to the more detailed description that is presented later.

One implementation provides for a system for content publishing. The system includes a processor and a computer-readable memory storage device storing executable instructions that can be executed by the processor to cause the processor to present a first code sample having a first functionality in response to a request for the first functionality. The executable instructions can be executed by the processor to detect an association between the first code sample and a second code sample having a second functionality. The association indicates the first code sample is dependent on the second code sample. The executable instructions can be executed by the processor to generate, in response to a selection of the first code sample, a build file based on the first code sample and the second code sample. The executable instructions can be executed by the processor to generate a package including the first functionality and the second functionality based on the build file.

Another implementation provides a method for content publishing. The method includes presenting a first code sample having a first functionality in response to a request for the first functionality. The method also includes detecting an association between the first code sample and the second code sample having a second functionality. The first functionality is dependent upon the second functionality. The method also includes generating, in response to a selection of the first code sample, a build file based on the first code sample and the second code sample. The method additionally includes generating a package including the first functionality and the second functionality. The method further also includes determining if a number of errors or warnings corresponding to the generation of the package exceeds a threshold value. The method also includes outputting the package in response to detecting the number of the errors or the warnings is below the threshold value or outputting a prerequisite in response to detecting the number of the errors or the warnings exceeds the threshold value.

Another implementation provides for one or more computer-readable memory storage devices for storing computer readable instructions that, when executed by one or more processing devices, instruct the performance of content publishing. The computer-readable instructions may include code to publish an elaborated code sample to a first repository and publish a basic code sample to a second repository. The computer-readable instructions may also include code to present the elaborated code sample from the first repository, the elaborated code sample having a first functionality, in response to a request for the first functionality. The computer-readable instructions include code to detect an association between the elaborated code sample and the basic code sample. The association indicates that the first functionality is dependent upon the second functionality. The computer-readable instructions may also include code to generate, in response to a selection of the elaborated code sample, a build file based on the elaborated code sample, the basic code sample, and a specified context of an application to consume the elaborated code sample and the basic code sample. The computer-readable instructions may include code to generate a package including the first functionality and the second functionality. The package may be an executable. The computer-readable instructions may include code to determine if a number of errors or warnings corresponding to the generation of the package exceeds a threshold value. Furthermore, the computer-readable instructions may include code to output the package in response to detecting the number of the errors or the warnings is below the threshold value or output a prerequisite in response to detecting the number of the errors or the warnings exceeds the threshold value.

The following description and the annexed drawings set forth in detail certain illustrative aspects of the disclosed subject matter. These aspects are indicative, however, of a few of the various ways in which the principles of the innovation may be employed and the disclosed subject matter is intended to include all such aspects and their equivalents. Other advantages and novel features of the disclosed subject matter will become apparent from the following detailed description of the innovation when considered in conjunction with the drawings.

### BRIEF DESCRIPTION OF THE DRAWINGS

FIG. 1 is a block diagram of an example system for content publishing;

FIG. 2 is a block diagram of another example system for content publishing;

FIG. 3 is a process flow diagram of an example method for content publishing;

FIG. 4 is a block diagram of an example operating environment configured for implementing various aspects of the techniques described herein; and

FIG. 5 is a block diagram showing example computer-readable storage media that can store instructions for the performance of content publishing.

### DETAILED DESCRIPTION

Currently, content publishers create large numbers of source code samples, also referred to herein as code samples, for clarity and brevity. Code samples may be of varying degrees of functionality, either basic or elaborated. The functionality of a basic code sample may be anything of a routine nature that would happen before the advanced functionality of an elaborated code sample. Basic code samples may include, for example, code that helps developers connect applications to a service, such as code for authentication, among others. For example, authentication may occur before performing a more advanced functionality, such as sending an email, sending a meeting request, or saving a file to a protected storage. Basic code samples for authenticating a user, for example, may thus be helpful if the developer wants to write a program that incorporates authentication. Publishing a basic code sample is typically followed by the publishing of elaborated code samples, such as the code for sending the email, sending a meeting request, or saving a file to a protected storage. An elaborated code sample, as used herein, includes source code that can perform an action based on a basic code sample. However, for programs that run the elaborated code sample to work properly, the basic code sample is also included in the elaborated code samples provided to developers. As such, portions of the basic code sample can be included in elaborated code samples, which can result in duplicate source code. Thus, there can be a large amount of duplicated source code in applications that implement both the basic and the elaborated code samples. This duplicative code can result in a wide variety of problems. For example, duplicate source code can increase the amount of source code to review when identifying and addressing issues with an application.

Duplicate source code can also increase the amount of time developers spend trying to find the actual code that performs the service they wish to perform. For example, a developer may be looking for a code sample that does something more complex than just sending an email, such as, sending an email with attachments or saving a file to a user authenticated space. The developer may go to a content publishing website to look for a code sample that performs this service. The content publishing website may allow the developer to browse through, and download, selected code samples. Browsing through elaborated code samples involves reading the actual source code of the code sample. However, it can be difficult for a developer distinguish between the elaborated code samples, e.g., code samples that send the email with attachments, when browsing a code sample that also includes all the basic code samples, e.g., code samples for authentication.

In one current technique in the art, the complete elaborated code sample, along with the basic code sample, is provided to the developer. The elaborated code sample is placed at the front of the source file. An alternative technique in the art involves attempting to bring the developer's attention to the elaborated code sample, such as pointing to the elaborated code sample in a “readme” file. However, these approaches still create a lot of duplicative, and thus hard to fix, code samples.

In another current technique in the art, only the elaborated code sample is provided. In this technique, comments may be placed inside an elaborated code sample that direct the developer to download an additional basic code sample for the elaborated code sample to work. However, this approach places overhead on the developer, who may prefer to download a code sample and run it without worrying about downloading the basic code samples.

Embodiments of the present techniques described herein provide a code sample selection framework that provides incremental code samples for developers to peruse and download. An incremental code sample may be a basic code sample or an elaborated code sample that may be viewed and downloaded by the developer. For example, an incremental code sample may include the basic code sample for user authentication; or, the elaborated code sample for saving a file to a user authorized space on the service. However, the elaborated code sample for saving the file does not include the basic code sample for connecting to the service. For developers that have not yet implemented or are unfamiliar with the basic code sample, the code sample selection framework enables developers to download the elaborated code sample and automatically obtain the basic code sample too, since the basic code sample is necessary to enable the functionality of the elaborated code sample. Consequently, the code sample selection framework provides for more precise correlation of elaborated code samples to the particular problem the developer is trying to solve. In this way, when developers are browsing through elaborated code samples, for example, on a content publishing website, the developer is only shown the piece of the elaborated code sample that solves the problem. The developer is thus not distracted by code in an elaborated code sample that is duplicated from a corresponding basic code sample. For example, the duplicated source code from the basic code sample may be source code that enables authentication. Advantageously, both the elaborated code samples and basic code samples exist in one, easier to maintain, place. Further, developers are not challenged to page, search, and peer through unnecessary code to find information for which they are interested.

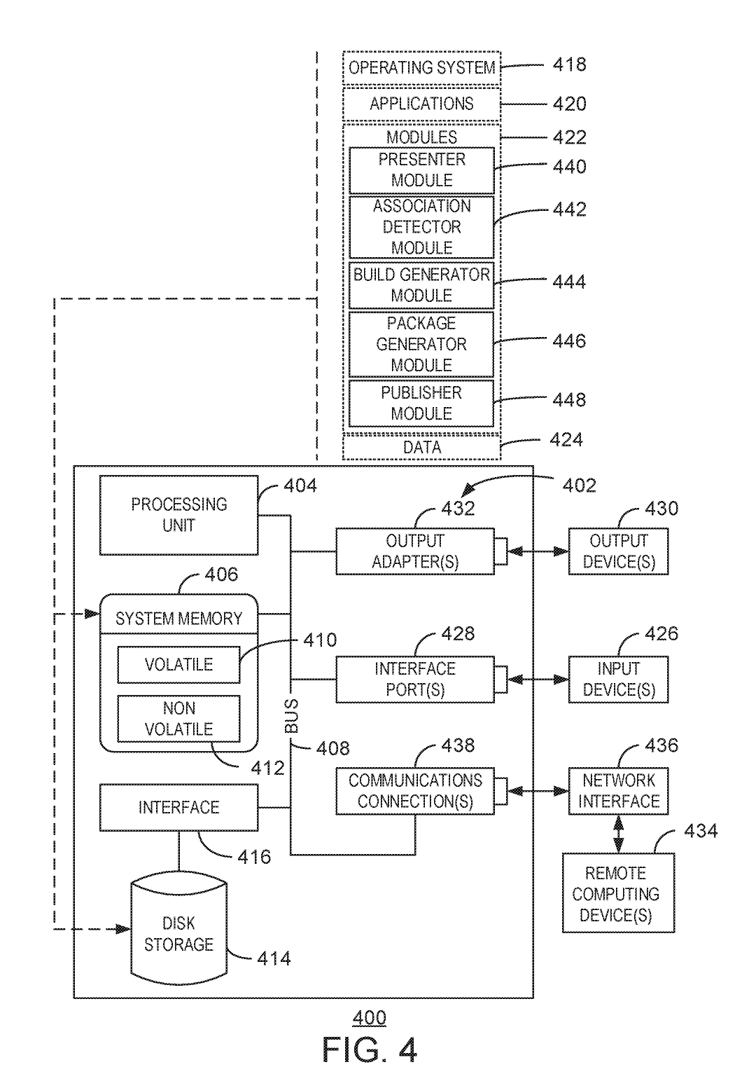

As a preliminary matter, some of the figures describe concepts in the context of one or more structural components, variously referred to as functionality, modules, features, elements, or the like. The various components shown in the figures can be implemented in any manner, such as software, hardware, firmware, or combinations thereof. In some cases, various components shown in the figures may reflect the use of corresponding components in an actual implementation. In other cases, any single component illustrated in the figures may be implemented by a number of actual components. The depiction of any two or more separate components in the figures may reflect different functions performed by a single actual component. FIG. 4, discussed below, provides details regarding one system that may be used to implement the functions shown in the figures.

Other figures describe the concepts in flowchart form. In this form, certain operations are described as constituting distinct blocks performed in a certain order. Such implementations are exemplary and non-limiting. Certain blocks described herein can be grouped together and performed in a single operation, certain blocks can be broken apart into multiple component blocks, and certain blocks can be performed in an order that differs from that which is illustrated herein, including a parallel manner of performing the blocks. The blocks shown in the flowcharts can be implemented by software, hardware, firmware, manual processing, or the like. As used herein, hardware may include computer systems, discrete logic components, such as application specific integrated circuits (ASICs), or the like.

As to terminology, the phrase “configured to” encompasses any way that any kind of functionality can be constructed to perform an identified operation. The functionality can be configured to perform an operation using, for instance, software, hardware, firmware, or the like. The term, “logic” encompasses any functionality for performing a task. For instance, each operation illustrated in the flowcharts corresponds to logic for performing that operation. An operation can be performed using, software, hardware, firmware, or the like. The terms, “component,” “system,” and the like may refer to computer-related entities, hardware, and software in execution, firmware, or combination thereof. A component may be a process running on a processor, an object, an executable, a program, a function, a subroutine, a computer, or a combination of software and hardware. The term, “processor,” may refer to a hardware component, such as a processing unit of a computer system.

Furthermore, the disclosed subject matter may be implemented as a method, apparatus, or article of manufacture using standard programming and engineering techniques to produce software, firmware, hardware, or any combination thereof to control a computing device to implement the disclosed subject matter. The term “article of manufacture,” as used herein is intended to encompass a computer program accessible from any computer-readable storage device or media. Computer-readable storage media include magnetic storage devices, e.g., hard disk, floppy disk, magnetic strips, optical disk, compact disk (CD), digital versatile disk (DVD), smart cards, flash memory devices, among others. Moreover, computer-readable storage media does not include communication media such as transmission media for wireless signals. In contrast, computer-readable media, i.e., not storage media, may include communication media such as transmission media for wireless signals.

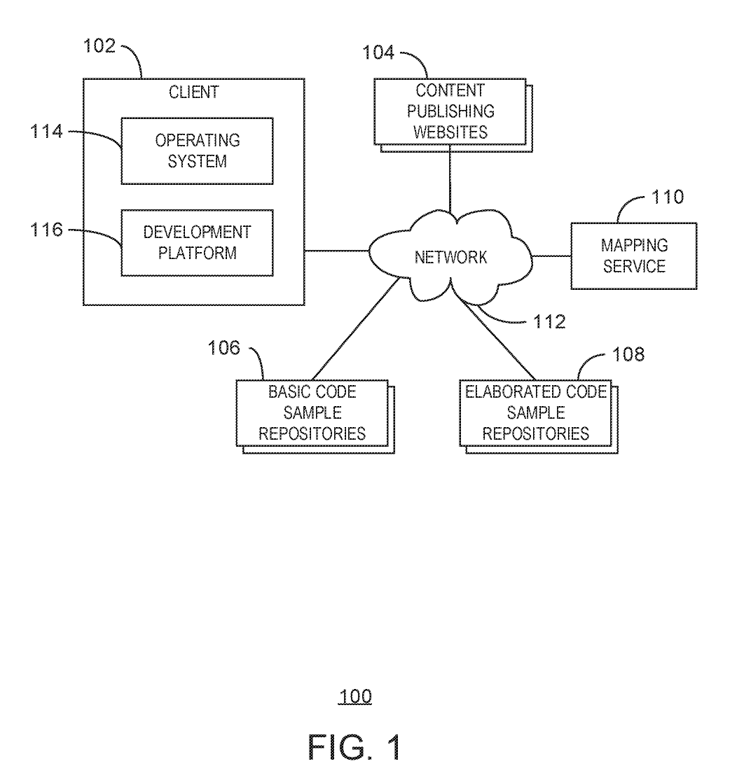

FIG. 1 is a block diagram of an example system 100 for content publishing. The system 100 includes a client 102 for a developer, content publishing websites 104, basic code sample repositories 106, elaborated code sample repositories 108, and mapping service 110, in communication over a network 112. The developer uses the client 102 to find and download build files for code samples published on the content publishing websites 104. Build files enable the developer to generate executables that the developer's own code can call to perform the specific services enabled by the code samples. The client 102 includes an operating system 114, and a development platform 116. Executables that run on the client 102 are operating-system dependent, meaning an executable generated for one operating system will not run on another operating system. The development platform 116 enables the developer to browse repositories of the content publishing website 104, download build files from the content publishing websites 104, develop source code, and generate and test executables built to run on the operating system 114. Additionally, the development platform 116 may enable the developer to “bolt in” an executable from an elaborated code sample that is not ready to be called from the developer's code yet. Bolting in, as used herein, refers to a method in which developers write their own code to perform some prerequisite functionality of the code sample. The development platform 116 may present to the developer one or more prerequisite conditions for running such executables.

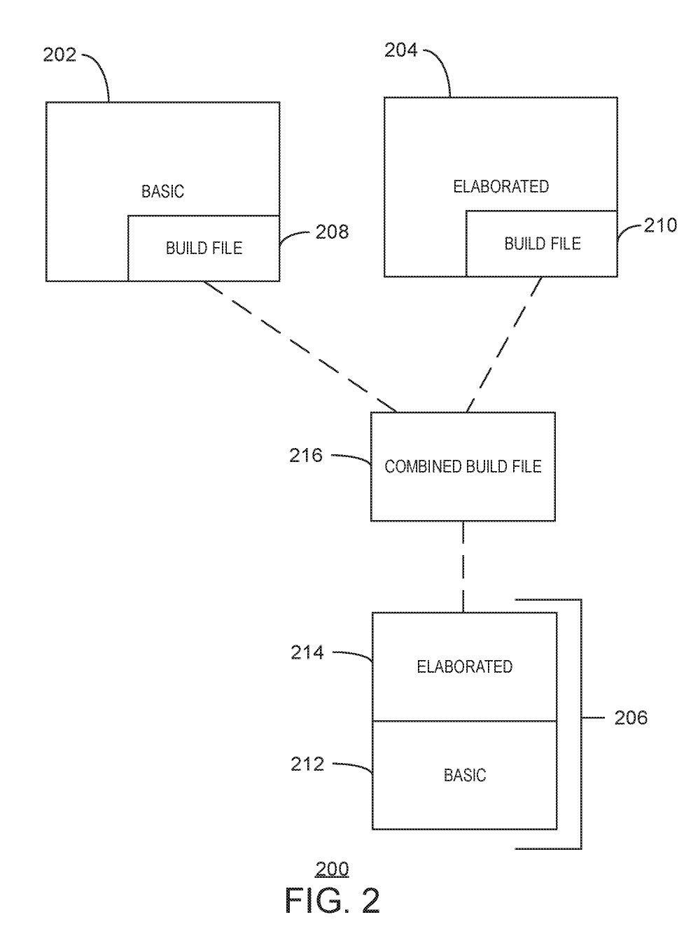

Examples of the system 100 can take several different forms depending on the development platform 110 where the code sample runs, and the location where the code sample is published. The location where the code sample is published may be the content publishing website 104. In an example implementation, the incremental code samples may be provided to run on the Android® Studio platform, and published to GitHub. There may be separate repositories on GitHub for the basic code sample and the elaborated code sample, such as basic code sample repositories 106 and elaborated code sample repositories 108. Having the basic and elaborated code samples in separate repositories enables developers to browse the code separately, which makes it possible find the elaborated code sample they want to use faster because there is less code to review. Once the elaborated code sample is found, the developer selects the elaborated code sample for download. However, the elaborated code sample relies on the code from a basic code sample to work. In the present examples, in response to the selection of a build file, code is automatically provided for both the basic and elaborated code samples. For example, the mapping service 110 may provide one or more associations between an elaborated code sample and one or more basic code samples. For example, the associations can be based on machine learning techniques, predetermined, and/or based on updated build files in the repositories as describe in greater detail below. A package can be generated based on the associations. For example, the elaborated code sample and any associated basic code samples can be included in the package. In some examples, build files may be used to indicate which basic code samples an elaborated code file may depend on, and which additional files the basic code samples may depend on, as described in FIG. 2 below.

FIG. 2 is a block diagram of an example system 200 for content publishing. The system 200 includes a basic code sample repository 202, an elaborated code sample repository 204, and a package 206. For example, an elaborated code sample may have been published to a first repository 204 and a basic code sample may have been published to a second repository 202. In some examples, the repositories 202, 204 may be on the same computing device or on different computing devices.

In the system 200, a developer interested in just a basic code sample can browse the basic code sample repository 202 and download a build file 208. For example, a developer may be interested in adding authentication support to an application. Similarly, a developer interested in just the elaborated code sample can browse just the elaborated code sample repository 204 and download the build file 210. For example, the developer may be interested in adding support for sending email within an organization to an application. When downloading either the build file 208 corresponding to the basic code sample or the build file 210 corresponding to the elaborated code sample, a package 206 may be created that can be compiled, built, and run. In some examples, the package 206 may be an executable that incorporates the functionality associated with the code samples 202, 204. For example, the build file 210 and the build file 208 can be combined into a combined build file 216. The build file 210 may have one or more references to one or more basic code samples including code sample 202 that each have their own associated build file 208. The build file 208 may have further references to one or more files that the basic code sample 202 may further depend on, such as libraries, etc. The combined build file 216 can be used to generate the package 206. For example, all the basic code samples including basic code sample 202 and associated files can be included with the elaborated code sample 204 in the package. In some examples, the package 206 can be a project that can be compiled, built, and executed with any suitable development platform that includes a set of programming tools to create an application. In some examples, the build file 210 can be used to create the package 206, which includes both at least one basic code sample 212 and an elaborated code sample 214. For example, the build file 210 can be updated and include a mapping of the elaborated code sample 204 to one or more basic code samples 202. In some examples, the package 206 can then be used with any suitable development environment. For example, the package 206 can be included in a software project developed using a particular development environment. For example, the development environment may be a Mac OS®, a Linux®, or a Windows® development environment. For example, the development environment may be Visual Studio®. Thus, the system 200 provides a useful framework that enables the developer to quickly find elaborated code samples without browsing through many related basic code samples. Moreover, basic code samples that are to be included in the application for use with the elaborated code samples are automatically included in packages that can be used in the development environment. For example, a basic code sample providing authentication functionality can be included in a package for emailing within an organization

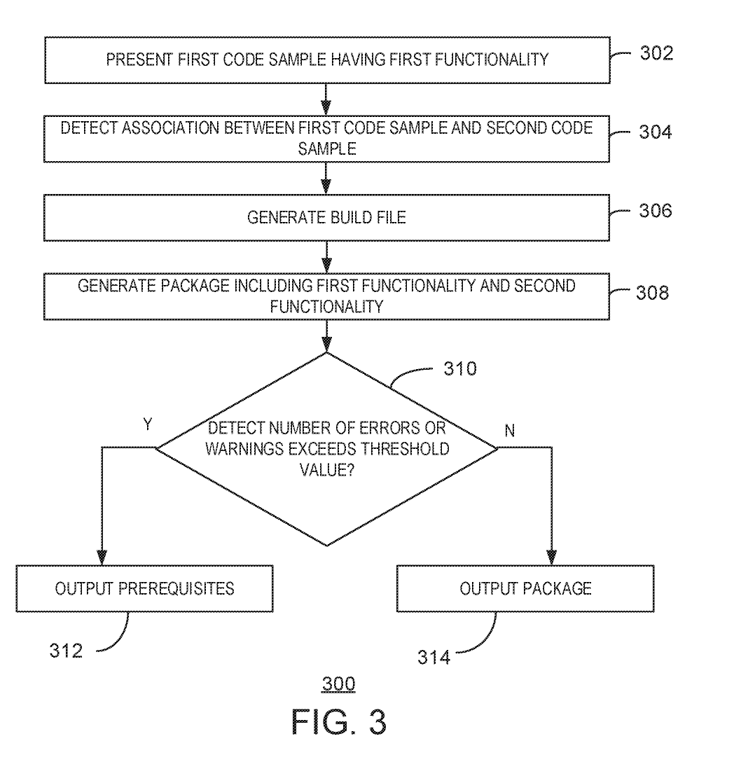

FIG. 3 is a process flow diagram of an example method for content publishing. One or more components of hardware or software of the operating environment 100, may be configured to perform the method 300. In some examples, various aspects of the method may be performed in a cloud computing system. The method 300 may begin at block 302.

At block 302, a first code sample having a first functionality may be presented in response to a request for the first functionality. For example, the first code sample may be an elaborated code. In some examples, the elaborated code sample may have been published to a first repository. In some examples, the basic code sample may have been published to a second repository. In some examples, the elaborated code sample from the first repository and/or the basic code sample from the second repository may be presented. For example, the elaborated code sample, the basic code sample, or both, can be displayed on a display for user inspection. In some examples, the elaborated code sample may be presented in response to a request for a particular functionality and the basic code sample may be presented once an elaborated code sample is selected. For example, a developer may be searching for an elaborated code sample that performs a specific functionality, such as sending an email within an organization. An elaborated code sample that sends email within an organization may accordingly be presented to the developer for review. The developer may then select the elaborated code sample for downloading.

At block 304, an association may be detected between the first code sample and a second code sample. For example, the first functionality of the first code sample may be dependent on a second functionality of the second code sample. In some examples, the first code sample may be an elaborated code sample and the second code sample may be an associated basic code sample. For example, the first functionality may enable emailing within an organization and the second functionality may enable authentication for users accessing emails. Thus, the elaborated code sample may include code that enables the emailing within an organization and the basic code sample may include code for authentication to be used by an application when emailing within the organization. In other examples, the basic code sample can create a website and the elaborated code sample can include additional functionality for the website such as adding navigation bars and shopping cart functions to the website, among others. In some examples, the functionality of the elaborated code sample may depend on the functionality of one or more basic code samples. In some examples, the associations can be predetermined. For example, the associations may be specified in a build file that indicates basic code samples or binaries to automatically retrieve. In some examples, an association file can map an elaborated code sample to one or more basic code samples. In some examples, the associations can be based on comments included in the basic code sample or the elaborated code sample. For example, a developer of an elaborated code sample may have included one or more comments associating the elaborated code sample with one or more basic code samples. The build file can be configured based on the included comments. In some examples, the associations can be determined using machine learning techniques. For example, based on previously received selections, any number of basic code samples can be associated with an elaborated code sample. Thus, in some examples, the associations can be determined based on previously generated build files. In some examples, the basic code samples can be identified using hashes. For example, a particular hash specified in an association file or comment in an elaborated code sample can be used to search for an associated basic code sample.

At block 306, in response to a selection of the first code sample, a build file may be generated. The build file may be based on the first code sample and the second code sample having the second functionality. In some examples, the build file may also be generated based on a specified context of an application to consume the first code sample and the second code sample. For example, the specified context may include a development stage of an application and other functionalities of the application under development, among other specified details of the application. In some examples, the build file may be configured to download one or more basic code samples and the elaborated code sample. For example, one or more basic code samples may be associated with the elaborated code sample. In some examples, the build file may be a combined build file. For example, the combined build file can be generated based on a build file associated with the first code sample and a build file associated with the second code sample. For example, a build file associated with an elaborated code sample may include a reference to one or more basic code files. The build file associated with the elaborated code sample can be combined with the build files associated with the one or more referenced basic code samples to form a combined build file that includes references to the elaborated codes sample, the referenced basic code samples, and any code referenced in the build files associated with the basic code samples. For example, the build files associated with the basic code samples may include references to one or more libraries or any other files that the basic code samples may depend on.

At block 308, a package including the first functionality and the second functionality can be generated. For example, the package may be an executable. In some examples, the package can be used with any suitable development environment. For example, the package can be run in the development environment to add the first functionality and second functionality to an application under development.

At block 310, a determination can be made as to whether a number of errors or warnings corresponding to the generation of the package exceeds a threshold value. If the number of errors or warning exceeds a predetermined threshold value, then the method may proceed at block 312. If the number of errors or warnings is below a predetermined threshold value, then the method may proceed at block 314.

At block 312, one or more prerequisites for processing the build file may be output in response to detecting the number of errors or warnings exceed the threshold value. A prerequisite, as referred to herein, can include any suitable value or data needed to generate the package. The prerequisites may be preconditions to be met in order for the first code sample and a second code sample to be extracted, and a package including a first functionality of the first code sample, and a second functionality of the second code sample to be generated. A prerequisite can include any suitable input required for the package to be generated without errors or warnings. The package may have not been able to be generated due to one or more of the preconditions not being met. For example, the basic code sample may not have been found. Thus, a link to the basic code sample can be provided or a basic code sample uploaded to meet the prerequisite. In some examples, multiple alternatives to the basic code sample may exist. Thus, a particular basic code sample may be selected in response to a list of alternatives being output. In some examples, the user may be instructed to use the dependency manager of the platform to obtain the prerequisites or execute the build process. For example, the user may choose a particular form of authentication to use and thus a particular basic code sample to be included in the package.

At block 314, a generated package is output in response to detecting a number of errors or warnings below a predetermined threshold value. In some examples, the generated package can then be imported and used in a development environment. For example, the package may include functionality for emailing within an organization using a particular form of authentication. The functionality for emailing within the organization using the particular form of authentication can be included in an application under development. A developer may then search for additional functionalities to include in the application, and browse through additional elaborated code samples as discussed above. In some examples, the package can be output in response to any threshold number of errors and/or warnings. For example, the instructions may output the package with any number of warnings as long as there are zero errors. Alternatively, the instructions may output the package with any number of errors below a threshold number. In some examples, the cause of an error can be modified and the package can be generated and output a second time.

This process flow diagram is not intended to indicate that the blocks of the method 300 are to be executed in any particular order, or that all of the blocks are to be included in every case. Further, any number of additional blocks not shown may be included within the method 300, depending on the details of the specific implementation.

FIG. 4 is intended to provide a brief, general description of an example operating environment in which the various techniques described herein may be implemented. For example, a method and system for content publishing can be implemented in such an operating environment. While the claimed subject matter has been described above in the general context of computer-executable instructions of a computer program that runs on a local computer or remote computer, the claimed subject matter also may be implemented in combination with other program modules. Generally, program modules include routines, programs, components, data structures, or the like that perform particular tasks or implement particular abstract data types. The example operating environment 400 includes a computer 402. The computer 402 includes a processing unit 404, a system memory 406, and a system bus 408.

The system bus 408 couples system components including, but not limited to, the system memory 406 to the processing unit 404. The processing unit 404 can be any of various available processors. Dual microprocessors and other multiprocessor architectures also can be employed as the processing unit 404.

The system bus 408 can be any of several types of bus structure, including the memory bus or memory controller, a peripheral bus or external bus, and a local bus using any variety of available bus architectures known to those of ordinary skill in the art. The system memory 406 includes computer-readable storage media that includes volatile memory 410 and nonvolatile memory 412.

The basic input/output system (BIOS), containing the basic routines to transfer information between elements within the computer 402, such as during start-up, is stored in nonvolatile memory 412. By way of illustration, and not limitation, nonvolatile memory 412 can include read-only memory (ROM), programmable ROM (PROM), electrically programmable ROM (EPROM), electrically erasable programmable ROM (EEPROM), or flash memory.

Volatile memory 410 includes random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), SynchLink™ DRAM (SLDRAM), Rambus® direct RAM (RDRAM), direct Rambus® dynamic RAM (DRDRAM), and Rambus® dynamic RAM (RDRAM).

The computer 402 also includes other computer-readable media, such as removable/non-removable, volatile/non-volatile computer storage media. FIG. 4 shows, for example a disk storage 414. Disk storage 414 includes, but is not limited to, devices like a magnetic disk drive, floppy disk drive, tape drive, Jaz drive, Zip drive, LS-210 drive, flash memory card, memory stick, flash drive, and thumb drive.

In addition, disk storage 414 can include storage media separately or in combination with other storage media including, but not limited to, an optical disk drive such as a compact disk, ROM device (CD-ROM), CD recordable drive (CD-R Drive), CD rewritable drive (CD-RW Drive), a digital versatile disk (DVD) drive. To facilitate connection of the disk storage devices 414 to the system bus 408, a removable or non-removable interface is typically used such as interface 416.

It is to be appreciated that FIG. 4 describes software that acts as an intermediary between users and the basic computer resources described in the suitable operating environment 400. Such software includes an operating system 418. The operating system 418, which can be stored on disk storage 414, acts to control and allocate resources of the computer 402.

System applications 420 take advantage of the management of resources by operating system 418 through program modules 422 and program data 424 stored either in system memory 406 or on disk storage 414. It is to be appreciated that the claimed subject matter can be implemented with various operating systems or combinations of operating systems.

A user enters commands or information into the computer 402 through input devices 426. Input devices 426 include, but are not limited to, a pointing device, such as, a mouse, trackball, stylus, and the like, a keyboard, a microphone, a joystick, a satellite dish, a scanner, a TV tuner card, a digital camera, a digital video camera, a web camera, and the like. The input devices 426 connect to the processing unit 404 through the system bus 408 via interface ports 428. Interface ports 428 include, for example, a serial port, a parallel port, a game port, and a universal serial bus (USB).

Output devices 430 use some of the same type of ports as input devices 426. Thus, for example, a USB port may be used to provide input to the computer 402, and to output information from computer 402 to an output device 430.

Output adapter 432 is provided to illustrate that there are some output devices 430 like monitors, speakers, and printers, among other output devices 430, which are accessible via adapters. The output adapters 432 include, by way of illustration and not limitation, video and sound cards that provide a means of connection between the output device 430 and the system bus 408. It can be noted that other devices and systems of devices can provide both input and output capabilities such as remote computers 434.

The computer 402 can be a server hosting various software applications in a networked environment using logical connections to one or more remote computers, such as remote computers 434. The remote computers 434 may be client systems configured with web browsers, PC applications, mobile phone applications, and the like.

The remote computers 434 can be a personal computer, a server, a router, a network PC, a workstation, a microprocessor based appliance, a mobile phone, a peer device or other common network node and the like, and typically includes many or all of the elements described relative to the computer 402. Remote computers 434 can be logically connected to the computer 402 through a network interface 436 and then connected via a communication connection 438, which may be wireless.

Network interface 436 encompasses wireless communication networks such as local-area networks (LAN) and wide-area networks (WAN). LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection 438 refers to the hardware/software employed to connect the network interface 436 to the bus 408. While communication connection 438 is shown for illustrative clarity inside computer 402, it can also be external to the computer 402. The hardware/software for connection to the network interface 436 may include, for exemplary purposes, internal and external technologies such as, mobile phone switches, modems including regular telephone grade modems, cable modems and DSL modems, ISDN adapters, and Ethernet cards.

An example processing unit 404 for the server may be a computing cluster. The disk storage 414 may include an enterprise data storage system, for example, holding thousands of impressions.

The computer 402 can be configured to publish content that includes elaborated and basic code samples. The data 424 may include one or more code samples, which may be obtained from a portable storage device or downloaded from a remote computer or via the Internet, for example.

The user may store the code samples to disk storage 414. The disk storage 414 can include a number of modules 422 configured to implement user authentication as described herein. For example, the disk storage 414 can include a presenter module 440 configured to present a first code sample having a first functionality in response to a request for the first functionality. For example, the first code sample can be an elaborated code sample.

Further, the disk storage 414 can include an association detector module 442 configured to detect an association between the first code sample and a second code sample having a second functionality. For example, the association can indicate that the first code sample is dependent on the second code sample. In some examples, the second code sample can be a basic code sample. For example, the basic code sample may be code for authentication and the second functionality may be authentication. The disk storage 414 can include a build generator module 444 configured to generate, in response to a selection of the first code sample, a build file based on the first code sample and the second code sample. The package generator module 446 can generate the package including the first functionality and the second functionality based on the build file. For example, the package can be an executable. In some examples, the presenter module 440 can present one or more prerequisites for processing the build file to extract the first code sample and the second code sample in response to detecting an error or a warning. In some examples, the presenter module 440 can output the package in response to generating the package with a number of errors or warnings below a threshold value. The presenter module 440 can output the package in response to any threshold number of errors and/or warnings. For example, the instructions may output the package with any number of warnings as long as there are zero errors. Alternatively, the presenter module 440 may output the package with any number of errors below a threshold number.

In some examples, the disk storage 414 can also include a publisher module 448 configured to publish the elaborated code sample to a first repository. In some examples, the publisher module 448 can be configured to publish the basic code sample to a second repository. Additionally, in some examples, the presenter module 440 may present the elaborated code sample from the first repository. In some examples, the presenter module 440 may present the basic code sample from the second repository.

In some examples, some or all of the processes performed for publishing content can be performed in a cloud service and reloaded on the client computer of the user. For example, some or all of the applications described above for publishing content could be running in a cloud service and receiving input from a user through a client computer.

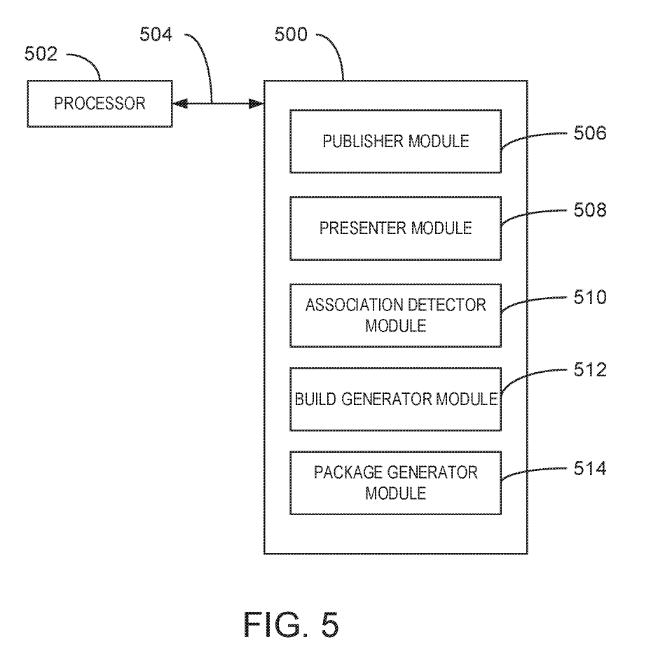

FIG. 5 is a block diagram showing computer-readable storage media 500 that can store instructions for the performance of content publishing. The computer-readable storage media 500 may be accessed by a processor 502 over a computer bus 504. Furthermore, the computer-readable storage media 500 may include code to direct the processor 502 to perform steps of the techniques disclosed herein.

The computer-readable storage media 500 can include code such as a publisher module 506 configured to publish the elaborated code sample to a first repository. In some examples, the publisher module 506 can be configured to publish the basic code sample to a second repository. A presenter module 508 can be configured to direct the processor 502 to present the elaborated code from the first repository, the elaborated code sample comprising a first functionality, in response to a request for the first functionality. In some examples, the presenter module 508 can present the basic code sample from the second repository, the basic code sample having a second functionality. For example, the second functionality may be an authentication functionality.

Further, the computer-readable storage media 500 can include an association detector module 510 configured to direct the processor 502 to detect an association between the elaborated code sample and the basic code sample. For example, the association may indicate that the first functionality is dependent upon a second functionality of the basic code sample. In some examples, the first functionality may be dependent upon one or more functionalities of a number of basic code samples.

The computer-readable storage media 500 can also include a build generator module 512 configured to generate, in response to a selection of the elaborated code sample, a build file based on the elaborated code sample, the basic code sample, and a specified context of an application to consume the elaborated code sample and the basic code sample. For example, the basic functionality may be authentication and the basic code sample may be code for authentication. In some examples, the presenter module 508 can display a prompt to receive the specified context. The package generator module 514 can generate a package including the first functionality and the second functionality based on the build file. For example, the package can be an executable. The presenter module 506 can output the package in response to detecting no errors or output a prerequisite in response to detecting an error.

It is to be understood that any number of additional software components not shown in FIG. 5 may be included within the computer-readable storage media 500, depending on the specific application. Although the subject matter has been described in language specific to structural features and/or methods, it is to be understood that the subject matter defined in the appended claims is not necessarily limited to the specific structural features or methods described above. Rather, the specific structural features and methods described above are disclosed as example forms of implementing the claims.

### Example 1

This example provides for an example system for content publishing. The example system includes a processor and a computer-readable memory storage device storing executable instructions that can be executed by the processor to cause the processor to present a first code sample having a first functionality in response to a request for the first functionality. The executable instructions can be executed by the processor to detect an association between the first code sample and a second code sample having a second functionality. The association indicates the first code sample is dependent on the second code sample. The executable instructions can be executed by the processor to generate, in response to a selection of the first code sample, a build file based on the first code sample and the second code sample. The executable instructions can be executed by the processor to generate a package including the first functionality and the second functionality based on the build file.

### Example 2

This example provides for an example system for content publishing. The example system includes a processor and a computer-readable memory storage device storing executable instructions that can be executed by the processor to cause the processor to present a first code sample having a first functionality in response to a request for the first functionality. The executable instructions can be executed by the processor to detect an association between the first code sample and a second code sample having a second functionality. The association indicates the first code sample is dependent on the second code sample. The executable instructions can be executed by the processor to generate, in response to a selection of the first code sample, a build file based on the first code sample and the second code sample. The executable instructions can be executed by the processor to generate a package including the first functionality and the second functionality based on the build file. The executable instructions can be executed by the processor to present one or more prerequisites for processing the build file to extract the first code sample and the second code sample in response to detecting an error or a warning.

### Example 3

This example provides for an example system for content publishing. The example system includes a processor and a computer-readable memory storage device storing executable instructions that can be executed by the processor to cause the processor to present a first code sample having a first functionality in response to a request for the first functionality. The executable instructions can be executed by the processor to detect an association between the first code sample and a second code sample having a second functionality. The association indicates the first code sample is dependent on the second code sample. The executable instructions can be executed by the processor to generate, in response to a selection of the first code sample, a build file based on the first code sample and the second code sample. The executable instructions can be executed by the processor to generate a package including the first functionality and the second functionality based on the build file. In addition, the executable instructions can be executed by the processor to output the package in response to generating the package with a number of errors or warnings below a threshold value.

### Example 4

This example provides for an example system for content publishing. The example system includes a processor and a computer-readable memory storage device storing executable instructions that can be executed by the processor to cause the processor to present a first code sample having a first functionality in response to a request for the first functionality. The executable instructions can be executed by the processor to detect an association between the first code sample and a second code sample having a second functionality. The association indicates the first code sample is dependent on the second code sample. The executable instructions can be executed by the processor to generate, in response to a selection of the first code sample, a build file based on the first code sample and the second code sample. The executable instructions can be executed by the processor to generate a package including the first functionality and the second functionality based on the build file. The package is an executable.

### Example 5

This example provides for an example system for content publishing. The example system includes a processor and a computer-readable memory storage device storing executable instructions that can be executed by the processor to cause the processor to present a first code sample having a first functionality in response to a request for the first functionality. The executable instructions can be executed by the processor to detect an association between the first code sample and a second code sample having a second functionality. The association indicates the first code sample is dependent on the second code sample. The executable instructions can be executed by the processor to generate, in response to a selection of the first code sample, a build file based on the first code sample and the second code sample. The executable instructions can be executed by the processor to generate a package including the first functionality and the second functionality based on the build file. Additionally, the first code sample is an elaborated code sample.

### Example 6

This example provides for an example system for content publishing. The example system includes a processor and a computer-readable memory storage device storing executable instructions that can be executed by the processor to cause the processor to present a first code sample having a first functionality in response to a request for the first functionality. The executable instructions can be executed by the processor to detect an association between the first code sample and a second code sample having a second functionality. The association indicates the first code sample is dependent on the second code sample. The executable instructions can be executed by the processor to generate, in response to a selection of the first code sample, a build file based on the first code sample and the second code sample. The executable instructions can be executed by the processor to generate a package including the first functionality and the second functionality based on the build file. Further, the second code sample is a basic code sample.

### Example 7

This example provides for an example system for content publishing. The example system includes a processor and a computer-readable memory storage device storing executable instructions that can be executed by the processor to cause the processor to present a first code sample having a first functionality in response to a request for the first functionality. The executable instructions can be executed by the processor to detect an association between the first code sample and a second code sample having a second functionality. The association indicates the first code sample is dependent on the second code sample. The executable instructions can be executed by the processor to generate, in response to a selection of the first code sample, a build file based on the first code sample and the second code sample. The executable instructions can be executed by the processor to generate a package including the first functionality and the second functionality based on the build file. Additionally, the executable instructions cause the computer processor to publish the elaborated code sample to a first repository. Also, the executable instructions cause the computer processor to publish the basic code sample to a second repository.

### Example 8

This example provides for an example system for content publishing. The example system includes a processor and a computer-readable memory storage device storing executable instructions that can be executed by the processor to cause the processor to present a first code sample having a first functionality in response to a request for the first functionality. The executable instructions can be executed by the processor to detect an association between the first code sample and a second code sample having a second functionality. The association indicates the first code sample is dependent on the second code sample. The executable instructions can be executed by the processor to generate, in response to a selection of the first code sample, a build file based on the first code sample and the second code sample. The executable instructions can be executed by the processor to generate a package including the first functionality and the second functionality based on the build file. Further, the executable instructions cause the computer processor to present the elaborated code sample from the first repository. Additionally, the executable instructions cause the computer processor to present the basic code sample from the second repository.

### Example 9

This example provides for an example method for content publishing. The example method includes presenting a first code sample having a first functionality in response to a request for the first functionality. The example method also includes detecting an association between the first code sample and the second code sample having a second functionality. The first functionality is dependent upon the second functionality. The example method further includes generating, in response to a selection of the first code sample, a build file based on the first code sample and the second code. The example method includes generating a package including the first functionality and the second functionality. The example method includes determining if a number of errors or warnings corresponding to the generation of the package exceeds a threshold value. The example method further includes outputting the package in response to detecting the number of the errors or the warnings is below the threshold value or outputting a prerequisite in response to detecting the number of the errors or the warnings exceeds the threshold value.

### Example 10

This example provides for an example method for content publishing. The example method includes presenting a first code sample having a first functionality in response to a request for the first functionality. The example method also includes detecting an association between the first code sample and the second code sample having a second functionality. The first functionality is dependent upon the second functionality. The example method further includes generating, in response to a selection of the first code sample, a build file based on the first code sample and the second code. The example method includes generating a package including the first functionality and the second functionality. The example method includes determining if a number of errors or warnings corresponding to the generation of the package exceeds a threshold value. The example method further includes outputting the package in response to detecting the number of the errors or the warnings is below the threshold value or outputting a prerequisite in response to detecting the number of the errors or the warnings exceeds the threshold value. In an example method, the package is an executable.

### Example 11

This example provides for an example method for content publishing. The example method includes presenting a first code sample having a first functionality in response to a request for the first functionality. The example method also includes detecting an association between the first code sample and the second code sample having a second functionality. The first functionality is dependent upon the second functionality. The example method further includes generating, in response to a selection of the first code sample, a build file based on the first code sample and the second code. The example method includes generating a package including the first functionality and the second functionality. The example method includes determining if a number of errors or warnings corresponding to the generation of the package exceeds a threshold value. The example method further includes outputting the package in response to detecting the number of the errors or the warnings is below the threshold value or outputting a prerequisite in response to detecting the number of the errors or the warnings exceeds the threshold value. In an example method, the first code sample is an elaborated code sample.

### Example 12

This example provides for an example method for content publishing. The example method includes presenting a first code sample having a first functionality in response to a request for the first functionality. The example method also includes detecting an association between the first code sample and the second code sample having a second functionality. The first functionality is dependent upon the second functionality. The example method further includes generating, in response to a selection of the first code sample, a build file based on the first code sample and the second code. The example method includes generating a package including the first functionality and the second functionality. The example method includes determining if a number of errors or warnings corresponding to the generation of the package exceeds a threshold value. The example method further includes outputting the package in response to detecting the number of the errors or the warnings is below the threshold value or outputting a prerequisite in response to detecting the number of the errors or the warnings exceeds the threshold value. In an example method, the first code sample is an elaborated code sample. Additionally, the example method includes publishing the elaborated code sample to a first repository.

### Example 13

This example provides for an example method for content publishing. The example method includes presenting a first code sample having a first functionality in response to a request for the first functionality. The example method also includes detecting an association between the first code sample and the second code sample having a second functionality. The first functionality is dependent upon the second functionality. The example method further includes generating, in response to a selection of the first code sample, a build file based on the first code sample and the second code. The example method includes generating a package including the first functionality and the second functionality. The example method includes determining if a number of errors or warnings corresponding to the generation of the package exceeds a threshold value. The example method further includes outputting the package in response to detecting the number of the errors or the warnings is below the threshold value or outputting a prerequisite in response to detecting the number of the errors or the warnings exceeds the threshold value. In an example method, the first code sample is an elaborated code sample. Additionally, the example method includes publishing the elaborated code sample to a first repository. Further, the second code sample is a basic code sample.

### Example 14

This example provides for an example method for content publishing. The example method includes presenting a first code sample having a first functionality in response to a request for the first functionality. The example method also includes detecting an association between the first code sample and the second code sample having a second functionality. The first functionality is dependent upon the second functionality. The example method further includes generating, in response to a selection of the first code sample, a build file based on the first code sample and the second code. The example method includes generating a package including the first functionality and the second functionality. The example method includes determining if a number of errors or warnings corresponding to the generation of the package exceeds a threshold value. The example method further includes outputting the package in response to detecting the number of the errors or the warnings is below the threshold value or outputting a prerequisite in response to detecting the number of the errors or the warnings exceeds the threshold value. In an example method, the first code sample is an elaborated code sample. Additionally, the example method includes publishing the elaborated code sample to a first repository. Further, the second code sample is a basic code sample. In addition, the example method includes publishing the basic code sample to a second repository.

### Example 15

This example provides for an example method for content publishing. The example method includes presenting a first code sample having a first functionality in response to a request for the first functionality. The example method also includes detecting an association between the first code sample and the second code sample having a second functionality. The first functionality is dependent upon the second functionality. The example method further includes generating, in response to a selection of the first code sample, a build file based on the first code sample and the second code. The example method includes generating a package including the first functionality and the second functionality. The example method includes determining if a number of errors or warnings corresponding to the generation of the package exceeds a threshold value. The example method further includes outputting the package in response to detecting the number of the errors or the warnings is below the threshold value or outputting a prerequisite in response to detecting the number of the errors or the warnings exceeds the threshold value. In an example method, the first code sample is an elaborated code sample. Additionally, the example method includes publishing the elaborated code sample to a first repository. Further, the second code sample is a basic code sample. In addition, the example method includes publishing the basic code sample to a second repository. Additionally, the example method includes presenting the elaborated code sample from the first repository. Further, the example method includes presenting the basic code sample from the second repository.

### Example 16

This example provides for an example one or more computer-readable memory storage devices for storing computer readable instructions that, when executed by one or more processing devices, instruct the performance of content publishing. The computer-readable instructions may include code to publish an elaborated code sample to a first repository and publish a basic code sample to a second repository. The computer-readable instructions may also include code to present the elaborated code from the first repository, the elaborated code sample comprising a first functionality, in response to a request for the first functionality. The computer-readable instructions may also include code to detect an association between the elaborated code sample and the basic code sample. The association indicates that the first functionality is dependent upon the second functionality. The computer-readable instructions may include code to generate, in response to a selection of the elaborated code sample, a build file based on the elaborated code sample, the basic code sample, and a specified context of an application to consume the elaborated code sample and the basic code sample. The computer-readable instructions may include code to generate a package including the first functionality and the second functionality based on the build file. The package is an executable. The computer-readable instructions may include code to determine if a number of errors or warnings corresponding to the generation of the package exceeds a threshold value. The computer-readable instructions may include code to output the package in response to detecting the number of the errors or the warnings is below the threshold value or output a prerequisite in response to detecting the number of the errors or the warnings exceeds the threshold value.

### Example 17

This example provides for an example one or more computer-readable memory storage devices for storing computer readable instructions that, when executed by one or more processing devices, instruct the performance of content publishing. The computer-readable instructions may include code to publish an elaborated code sample to a first repository and publish a basic code sample to a second repository. The computer-readable instructions may also include code to present the elaborated code from the first repository, the elaborated code sample comprising a first functionality, in response to a request for the first functionality. The computer-readable instructions may also include code to detect an association between the elaborated code sample and the basic code sample. The association indicates that the first functionality is dependent upon the second functionality. The computer-readable instructions may include code to generate, in response to a selection of the elaborated code sample, a build file based on the elaborated code sample, the basic code sample, and a specified context of an application to consume the elaborated code sample and the basic code sample. The computer-readable instructions may include code to generate a package including the first functionality and the second functionality based on the build file. The package is an executable. The computer-readable instructions may include code to determine if a number of errors or warnings corresponding to the generation of the package exceeds a threshold value. The computer-readable instructions may include code to output the package in response to detecting the number of the errors or the warnings is below the threshold value or output a prerequisite in response to detecting the number of the errors or the warnings exceeds the threshold value. In addition, the computer-readable instructions may also include code to present the basic code sample from the second repository, the basic code sample having a second functionality.

### Example 18

This example provides for an example one or more computer-readable memory storage devices for storing computer readable instructions that, when executed by one or more processing devices, instruct the performance of content publishing. The computer-readable instructions may include code to publish an elaborated code sample to a first repository and publish a basic code sample to a second repository. The computer-readable instructions may also include code to present the elaborated code from the first repository, the elaborated code sample comprising a first functionality, in response to a request for the first functionality. The computer-readable instructions may also include code to detect an association between the elaborated code sample and the basic code sample. The association indicates that the first functionality is dependent upon the second functionality. The computer-readable instructions may include code to generate, in response to a selection of the elaborated code sample, a build file based on the elaborated code sample, the basic code sample, and a specified context of an application to consume the elaborated code sample and the basic code sample. The computer-readable instructions may include code to generate a package including the first functionality and the second functionality based on the build file. The package is an executable. The computer-readable instructions may include code to determine if a number of errors or warnings corresponding to the generation of the package exceeds a threshold value. The computer-readable instructions may include code to output the package in response to detecting the number of the errors or the warnings is below the threshold value or output a prerequisite in response to detecting the number of the errors or the warnings exceeds the threshold value. In addition, the second functionality includes an authentication functionality.

### Example 19

This example provides for an example one or more computer-readable memory storage devices for storing computer readable instructions that, when executed by one or more processing devices, instruct the performance of content publishing. The computer-readable instructions may include code to publish an elaborated code sample to a first repository and publish a basic code sample to a second repository. The computer-readable instructions may also include code to present the elaborated code from the first repository, the elaborated code sample comprising a first functionality, in response to a request for the first functionality. The computer-readable instructions may also include code to detect an association between the elaborated code sample and the basic code sample. The association indicates that the first functionality is dependent upon the second functionality. The computer-readable instructions may include code to generate, in response to a selection of the elaborated code sample, a build file based on the elaborated code sample, the basic code sample, and a specified context of an application to consume the elaborated code sample and the basic code sample. The computer-readable instructions may include code to generate a package including the first functionality and the second functionality based on the build file. The package is an executable. The computer-readable instructions may include code to determine if a number of errors or warnings corresponding to the generation of the package exceeds a threshold value. The computer-readable instructions may include code to output the package in response to detecting the number of the errors or the warnings is below the threshold value or output a prerequisite in response to detecting the number of the errors or the warnings exceeds the threshold value. In addition, the computer-readable instructions may include code to present the basic code sample from the second repository.

### Example 20

This example provides for an example one or more computer-readable memory storage devices for storing computer readable instructions that, when executed by one or more processing devices, instruct the performance of content publishing. The computer-readable instructions may include code to publish an elaborated code sample to a first repository and publish a basic code sample to a second repository. The computer-readable instructions may also include code to present the elaborated code from the first repository, the elaborated code sample comprising a first functionality, in response to a request for the first functionality. The computer-readable instructions may also include code to detect an association between the elaborated code sample and the basic code sample. The association indicates that the first functionality is dependent upon the second functionality. The computer-readable instructions may include code to generate, in response to a selection of the elaborated code sample, a build file based on the elaborated code sample, the basic code sample, and a specified context of an application to consume the elaborated code sample and the basic code sample. The computer-readable instructions may include code to generate a package including the first functionality and the second functionality based on the build file. The package is an executable. The computer-readable instructions may include code to determine if a number of errors or warnings corresponding to the generation of the package exceeds a threshold value. The computer-readable instructions may include code to output the package in response to detecting the number of the errors or the warnings is below the threshold value or output a prerequisite in response to detecting the number of the errors or the warnings exceeds the threshold value. In addition, the computer-readable instructions may also include code to display a prompt to receive the specified context.

What has been described above includes examples of the disclosed subject matter. It is, of course, not possible to describe every conceivable combination of components or methodologies for purposes of describing the disclosed subject matter, but one of ordinary skill in the art may recognize that many further combinations and permutations of the disclosed subject matter are possible. Accordingly, the disclosed subject matter is intended to embrace all such alterations, modifications, and variations that fall within the spirit and scope of the appended claims. [NK] In particular and in regard to the various functions performed by the above described components, devices, circuits, systems and the like, the terms (including a reference to a “means”) used to describe such components are intended to correspond, unless otherwise indicated, to any component which performs the specified function of the described component, e.g., a functional equivalent, even though not structurally equivalent to the disclosed structure, which performs the function in the herein illustrated exemplary aspects of the disclosed subject matter. In this regard, it will also be recognized that the innovation includes a system as well as a computer-readable storage media having computer-executable instructions for performing the acts and events of the various methods of the disclosed subject matter.

There are multiple ways of implementing the disclosed subject matter, e.g., an appropriate API, tool kit, driver code, operating system, control, standalone or downloadable software object, etc., which enables applications and services to use the techniques described herein. The disclosed subject matter contemplates the use from the standpoint of an API (or other software object), as well as from a software or hardware object that operates according to the techniques set forth herein. Thus, various implementations of the disclosed subject matter described herein may have aspects that are wholly in hardware, partly in hardware and partly in software, as well as in software.

The aforementioned systems have been described with respect to interaction between several components. It can be appreciated that such systems and components can include those components or specified sub-components, some of the specified components or sub-components, and additional components, and according to various permutations and combinations of the foregoing. Sub-components can also be implemented as components communicatively coupled to other components rather than included within parent components (hierarchical).

Additionally, it can be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but generally known by those of skill in the art.

In addition, while a particular feature of the disclosed subject matter may have been disclosed with respect to one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

What is claimed is:

1. A system for content publishing, comprising:
a computer processor; and
a computer memory, comprising instructions that cause the computer processor to:
present a first code sample having a first functionality in response to a request for the first functionality;
detect an association between the first code sample and a second code sample having a second functionality, wherein the association indicates the first code sample is dependent on the second code sample;
generate, in response to a selection of the first code sample, a build file based on the first code sample and the second code sample; and
generate a package comprising the first functionality and the second functionality based on the build file.

2. The system of claim 1, the computer memory comprising instructions that cause the computer processor to present one or more prerequisites for processing the build in response to detecting an error or a warning.

3. The system of claim 1, the computer memory comprising instructions that cause the computer processor to output the package in response to generating the package with a number of errors or warnings below a threshold value.

4. The system of claim 1, wherein the package comprises an executable.

5. The system of claim 4, wherein the first code sample comprises an elaborated code sample.

6. The system of claim 5, wherein the second code sample comprises a basic code sample.

7. The system of claim 6, the computer memory comprising instructions that cause the computer processor to publish the elaborated code sample to a first repository and publish the basic code sample to a second repository.

8. The system of claim 7, the computer memory comprising instructions that cause the computer processor to:
present the elaborated code sample from the first repository; and
present the basic code sample from the second repository.

9. A method of content publishing, comprising:
presenting a first code sample having a first functionality in response to a request for the first functionality;
detecting an association between the first code sample and the second code sample having a second functionality, wherein the first functionality is dependent upon the second functionality;
generating, in response to a selection of the first code sample, a build file based on the first code sample and the second code sample;
generating a package comprising the first functionality and the second functionality;
determining if a number of errors or warnings corresponding to the generation of the package exceeds a threshold value; and
outputting the package in response to detecting the number of the errors or the warnings is below the threshold value or outputting a prerequisite in response to detecting the number of the errors or the warnings exceeds the threshold value.

10. The method of claim 9, wherein the package comprises an executable.

11. The method of claim 9, wherein the first code sample comprises an elaborated code sample.

12. The method of claim 11, comprising publishing the elaborated code sample to a first repository.

13. The method of claim 12, wherein the second code sample comprises a basic code sample.

14. The method of claim 13, comprising publishing the basic code sample to a second repository.

15. The method of claim 14, comprising:
presenting the elaborated code sample from the first repository; and
presenting the basic code sample from the second repository.

16. A computer-readable storage device for content publishing, comprising instructions that cause a computer processor to:
publish an elaborated code sample to a first repository and publish a basic code sample to a second repository;
present the elaborated code from the first repository, the elaborated code sample comprising a first functionality, in response to a request for the first functionality;
detect an association between the elaborated code sample and the basic code sample, wherein the association indicates that the first functionality is dependent upon a second functionality of the basic code sample;
generate, in response to a selection of the elaborated code sample, a build file based on the elaborated code sample, the basic code sample, and a specified context of an application to consume the elaborated code sample and the basic code sample;
generate a package comprising the first functionality and the second functionality based on the build file, wherein the package comprises an executable;
determine if a number of errors or warnings corresponding to the generation of the package exceeds a threshold value; and
output the package in response to detecting the number of the errors or the warnings is below the threshold value or output a prerequisite in response to detecting the number of the errors or the warnings exceeds the threshold value.

17. The computer-readable storage device of claim 16, further comprising instructions that cause the computer processor to present the basic code sample from the second repository, the basic code sample having a second functionality.

18. The computer-readable storage device of claim 16, wherein the second functionality comprises an authentication functionality.

19. The computer-readable storage device of claim 16, further comprising instructions that cause the computer processor to present the basic code sample from the second repository.

20. The computer-readable storage device of claim 16, comprising instructions that cause the computer processor to display a prompt to receive the specified context.
